(19) United States
(12) Patent Application Publication
(10) Pub. No.: US 2013/0205925 A1
(43) Pub. Date: Aug. 15, 2013

(54) Drive Train Having a Hydrodynamic Retarder and Method for Adjusting the Braking Torque

(71) Applicants: Tilman Huth, Satteldorf (DE); Dieter Laukemann, Crailsheim (DE)

(72) Inventors: Tilman Huth, Satteldorf (DE); Dieter Laukemann, Crailsheim (DE)

(21) Appl. No.: 13/817,528

(22) PCT Filed: Aug. 9, 2011
(86) PCT No.: PCT/EP2011/003968

§ 371 Date: Apr. 25, 2013

(30) Foreign Application Priority Data
Nov. 19, 2010 (DE) 10 2010 051 717.8

(51) Int. Cl. F16H 41/30

(52) U.S. Cl. CPC F16H 41/30
USPC 74/15.82

(57) ABSTRACT

The invention relates to a drive train, especially a motor vehicle
with a drive engine, comprising a main output shaft, by means of which the drive wheels or any other unit can be driven;
with a hydrodynamic retarder, comprising a driven bladed primary wheel and a bladed secondary wheel which is stationary or driven in opposite direction to the primary wheel, said wheels jointly forming a toroidal working chamber which is or can be filled with working medium in order to transfer torque hydrodynamically from the primary wheel to the secondary wheel;
the drive motor comprises a power take-off shaft via which the primary wheel of the retarder is driven.

The invention is characterized in that the hydrodynamic retarder is arranged as a single-step, uncontrolled retarder which can be switched exclusively between an activated state and a deactivated state.

The present invention relates to a drive train with a hydrodynamic retarder, especially a motor vehicle drive train, in detail according to the preamble of claim 1. The present invention further relates to a method for setting the braking torque of a hydrodynamic retarder in such a drive train.

Hydrodynamic retarders have long been used as wear-free sustained-action brakes in motor vehicles and also in stationary installations. One conventionally distinguishes between primary retarders which operate depending on the speed of the drive motor and secondary retarders which are arranged on the transmission output shaft or a power take-off of the transmission and therefore work depending on the speed of the transmission output shaft and therefore depending on the travelling speed.

Primary retarders arranged on the primary side of the drive motor are described for example in the specifications DE 44 08 349, DE 44 08 350, DE 44 40 162 and DE 199 39 726.

DE 44 46 288 describes a primary retarder on the primary side of the engine, and a second retarder which is arranged as the secondary retarder on the output side of the transmission.

Document DE 198 40 284 A1 describes a primary retarder which is directly arranged on the input shaft of the transmission.

Document DE 2 017 617 describes a hydrodynamic retarder which is arranged laterally on the transmission and whose rotor is in engagement via an intermediate gearwheel with a gearwheel of the transmission, e.g. the head gearwheel at the front end of the countershaft of the transmission.

Document DE 44 45 024 describes a retarder arranged on the secondary side on a booster of the transmission.

DE 196 41 557 A1 describes a retarder operated depending on the travelling speed, i.e. the secondary retarder, which can also be arranged on the primary side of the transmission, especially together with a water pump.

Document EP 1 548 315 B1 describes the arrangement of a hydrodynamic retarder on a power take-off, which is a so-called power take-off of the drive engine in a housing carried by the drive engine, with the retarder drive shaft having a flange for the connection of a further auxiliary unit.

Although numerous possibilities for the arrangement of a hydrodynamic retarder in the drive train have already been proposed, there is a continuing need for integrating the retarder in a cost-effective manner in the drive train.

The invention is therefore based on the object of providing a drive train with a hydrodynamic retarder and a method for setting the braking torque with such a retarder in which an integration and especially retrofitting the retarder is possible in an especially cost-effective way. The integration shall minimize the need for reconfiguration of the drive train to the highest possible extent, optimally utilize the available space, and effectively use the existing components for the integration of the retarder. The effort for the integration shall be minimal.

The object in accordance with the invention will be achieved by a drive train with the features of claim 1 and a method with the features of claim 8. The dependent claims describe advantageous and especially appropriate embodiments of the invention.

A drive train in accordance with the invention, especially a drive train for a motor vehicle, comprises a drive engine with a main output shaft. The drive wheels or another unit will be driven by means of the main output shaft. Usually, a transmission input shaft of a transmission connected in series with the drive engine in the drive power flow is connected with the main output shaft. The transmission is advantageously arranged as a gear change transmission, especially as an automatic transmission, semi-automatic gear box or manual gear box. Other types of transmission such as continuously variable transmissions or dual-clutch transmissions can be considered. The drive wheels of the motor vehicle are usually respectively driven by the drive engine via the transmission, usually by interposing a cardan shaft.

Alternatively, the invention can also be applied in the case of a stationary drive train in which a unit is driven via the transmission by the drive engine. Also in the case of application in a motor vehicle, the transmission can be arranged in the drive power flow between the drive engine and a unit of the motor vehicle which is to be driven by means of the drive engine.

The drive engine is usually arranged as an internal combustion engine, with the main output shaft being arranged as a crankshaft.

The drive train in accordance with the invention further comprises a hydrodynamic retarder, comprising a driven bladed primary wheel which is also known as the rotor, and a bladed secondary wheel which is stationary or is driven in opposite direction to the primary wheel. When the secondary wheel is driven in opposite direction to the primary wheel, a counter-rotating retarder is formed. When the secondary wheel is stationary, it is known as a stator.

The primary wheel and the secondary wheel jointly form a working chamber which can be filled or is filled with a working medium and in which a circuit flow of a working medium is obtained in braking operation in order to transfer torque hydrodynamically from the primary wheel to the secondary wheel and to thereby brake the primary wheel.

The drive engine further comprises a power take-off shaft, via which the primary wheel of the hydrodynamic retarder is driven. The hydrodynamic retarder is advantageously positioned on the side of the transmission connected to the power take-off shaft of the drive engine.

In accordance with the invention, the hydrodynamic retarder is arranged as a single-step uncontrolled retarder, which can exclusively be switched between an activated state and a deactivated state. Accordingly, the retarder does not comprise any control or feedback control of various braking torque steps which are usually provided otherwise and which can usually be retrieved via a retarder operating handle by the vehicle operator or a driver assistance system. Rather, the retarder can therefore only be activated or deactivated so to speak in black/white.

It is especially advantageous when the retarder is dimensioned with respect to its power transmission capability and its maximum braking torque and is arranged in a cooled configuration especially by means of the vehicle cooling circuit in such a way that a so-called down-regulation of the temperature of the maximum braking torque can be avoided. Such a temperature down-regulation conventionally provides detecting the temperature of the working medium and/or the cooling medium and/or limiting the speed of the cooling medium pump which is driven by the drive engine and which circulates the cooling medium, or directly limiting the speed of the drive engine in order to limit the maximum adjustable retarder braking torque depending on these quantities. Other braking torque down-regulations provide not using the temperature of the working medium directly for down-regulation, but the speed of the rise in temperature of the working medium and/or the cooling medium.

Due to the fact that the hydrodynamic retarder in accordance with the invention is uncontrolled in accordance with the invention and therefore advantageously is also arranged without such a temperature down-regulation, the inclusion in the drive train can occur in an especially cost-effective way. Furthermore, such a retarder integrated in accordance with the invention has proven to be exceptionally sturdy in operation and shows little susceptibility to malfunctions, especially in the triggering system, because there is simple activation/deactivation.

Especially when the hydrodynamic retarder is arranged as an oil retarder with the working medium of oil, it is advantageous that the hydrodynamic retarder comprises a heat exchanger via which heat is dissipated from the working medium. The dissipation can occur into the ambient environment or according to another embodiment in a vehicle cooling circuit which is connected with respect to heat transmission on the secondary side of the heat exchanger and via which especially the drive engine is also cooled. Such a vehicle cooling circuit usually comprises a cooling medium pump which can be driven by the drive engine or any other motor, especially an electric motor or hydraulic motor.

According to an alternative embodiment, the hydrodynamic retarder is directly integrated in the vehicle cooling circuit, with especially the drive engine being cooled by means of the cooling circuit. The working medium of the retarder is simultaneously the cooling medium of the vehicle cooling circuit, especially water or water mixture.

According to an especially advantageous embodiment of the invention, the retarder is not connected on the conventionally used primary side of the drive engine remote from the transmission, but as a primary retarder with a power take-off of the drive engine the side of the transmission, therefore on the secondary side of the drive engine. The arrangement therefore does not require any space in the region of the main output shaft of the drive engine or the transmission input shaft of the transmission connected in series with the drive engine, and the transmission housing can skillfully be used when required for storing individual components of the retarder, especially the secondary wheel of the retarder or the entire retarder. At the same time, the power take-offs of the drive engine on its primary side, which are also known as PTOs, remain free for other auxiliary units without giving rise to the necessity as explained above of providing on the retarder drive shaft a further flange for accommodating or connecting further auxiliary units. This does not mean that in the present arrangement in accordance with the invention such a possibility for connection cannot be provided on the secondary side of the drive engine.

The activation and deactivation of the retarder occurs according to a first embodiment of the invention by interrupting the drive of the primary wheel, especially by means of a synchronizing clutch. In addition or alternatively, in the case of a secondary wheel which is driven in opposite direction to the primary wheel it is also possible to interrupt the drive of the secondary wheel, especially by means of a synchronizing clutch. The stationary secondary wheel also offers the possibility to selectively interrupt support of the secondary wheel against twisting, especially by means of a synchronizing clutch.

It is understood that clutches other than synchronizing clutches can be considered, e.g. non-synchronized clutches which can be engaged between the two clutch halves with low or no slip.

In accordance with an alternative embodiment of the invention or in addition to the described interruption of the drives or the support, the retarder can be associated with a filling device for the selective filling of the working chamber with working medium, and the filling device for activating the retarder can release a feed line for working medium into the working chamber or displace a predetermined working medium storage volume into the working chamber. For deactivation, the feed line can be blocked and/or a discharge for the working medium from the working chamber can be opened, especially by the filling device. Alternatively, the filling device or an additionally provided discharging device can discharge the working medium from the working chamber.

The filling device can comprise a filling cylinder for example which upon activating the retarder displaces its working medium content especially in an uncontrolled manner into the working chamber and aspirates working medium from the working chamber during deactivation of the retarder. Other possibilities for arrangements such as an elastic membrane or an elastic working medium storage space wall which work accordingly are also possible.

The method in accordance with the invention for setting the braking torque of the hydrodynamic retarder in a drive train in accordance with the invention provides that the braking torque is varied or switched in two stages, without any further stages, exclusively between a deactivated state of the retarder in which no braking torque is generated with the retarder and an activated state in which the retarder generates braking torque in one single shifting step. In the activated state of the braking torque, the setting of the braking torque advantageously occurs independent of the temperature of the working medium or without any other temperature down-regulation, i.e. without any limitation of the maximum braking torque depending on external or internal control quantities which are to prevent overheating.

The invention will be explained below in closer detail by way of example by reference to an embodiment.

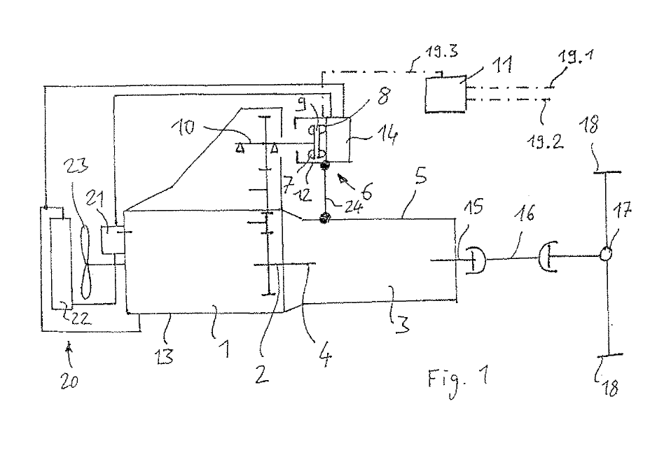

FIG. 1 shows a drive engine 1 with a transmission 3 which is connected directly to said engine. The drive engine 1 comprises a main output shaft 2 which is in connection with a transmission input shaft 4. A clutch (not shown) can optionally be provided in said drive connection in order to separate the transmission input shaft 4 from the main output shaft 2 of the drive engine 1.

The drive engine 1 comprises an engine housing 13 and the transmission 3 comprises a transmission housing 5, which enclose the respective components of these parts. Various gear ratios between the transmission input shaft 4 and a transmission output shaft 15 can be produced in the transmission 3 by shifting respective clutches and/or brakes. The transmission output shaft 15 drives drive wheels 18 of the motor vehicle via a cardan shaft 16 and the differential gear 17.

A hydrodynamic retarder 6, which comprises a revolving primary wheel 7 and a stationary secondary wheel 8 which jointly form a toroidal working chamber 9, is connected to a power take-off shaft 10 of the drive engine 1 on its secondary side. The hydrodynamic retarder 6 comprises a retarder housing 12 which encloses the primary wheel 7 and the secondary wheel 8 and in which the secondary wheel 8 is supported in a torsion-proof manner. The primary wheel 7 is mounted in a floating manner on the power take-off shaft 10 and only the secondary wheel 8 will be carried in the retarder housing 12. Alternatively, the primary wheel 7 could also be mounted on a respective retarder input shaft which is directly or indirectly connected to the PTO shaft 10.

A heat exchanger 14 is further connected with the retarder housing 12, said heat exchanger being carried by the retarder housing 12. The heat exchanger 14 is incorporated in a vehicle cooling circuit 20 in order to cool the working medium of the retarder 6. The drive engine 1 is also cooled by means of the vehicle cooling circuit 20. A cooling medium pump 21 is arranged in the vehicle cooling circuit 20 and a radiator 22 in order to dissipate heat to the ambient environment from the vehicle cooling circuit 20, optionally by means of the fan 23 which is driven by the vehicle drive engine 1. The cooling medium pump 21 is arranged on the primary side of the drive engine 1 on a power take-off, as also the fan 23 accordingly.

The power take-off shaft 10 is mounted within the engine housing 13 and is in drive connection via interposed gearwheel steps with the main output shaft 2 which is arranged in an internal combustion engine as a crankshaft.

The retarder housing 12 can be supported against twisting on the transmission housing 5 (see the torque support 24 which is shown by way of example). Alternatively, the retarder housing 12 could also be carried completely by the transmission housing 5 and/or by the engine housing 13.

The retarder 6 is associated with a control device 11 which is connected via a control line 19.3 with the hydrodynamic retarder 6. The control device 11 activates and deactivates the hydrodynamic retarder 6, e.g. depending on input signals which are obtained by said control device via the control lines 19.1 and 19.2. It receives control commands for example by a vehicle operator via the control line 19.1, who can command the activation and deactivation of the retarder 6 by means of a button or any other input unit. The control device 11 receives input signals of a driver assistance system by the control line 19.2, e.g. automatic adaptive cruise control or a speed controller which can also command the activation and deactivation of the retarder 6.

1-9. (canceled)

10. A drive train, especially of a motor vehicle,
with a drive engine, comprising a main output shaft for driving drive wheels or any other unit;
with a hydrodynamic retarder, comprising a driven bladed primary wheel and a bladed secondary wheel which is stationary or driven in opposite direction to the primary wheel, said wheels jointly forming a toroidal working chamber which is or can be filled with working medium in order to transfer torque hydrodynamically from the primary wheel to the secondary wheel;
the drive engine comprises a power take-off shaft, via which the primary wheel of the retarder is driven;
characterized in that
the hydrodynamic retarder is arranged as a single-step, uncontrolled retarder which can be switched exclusively between an activated state and a deactivated state.

11. The drive train according to claim 10, characterized in that the hydrodynamic retarder comprises a heat exchanger, via which heat is dissipated from the working medium, especially oil, to the ambient environment or to a vehicle cooling circuit which is connected concerning heat transmission on the secondary side with the heat exchanger, with the drive engine also especially being cooled by said cooling circuit.

12. The drive train according to claim 10, characterized in that the hydrodynamic retarder is arranged in a vehicle cooling circuit, by means of which the drive engine is especially also cooled, and the working medium of the retarder is simultaneously the cooling medium of the vehicle cooling circuit, especially water or a water mixture.

13. The drive train according to claim 10, characterized in that the retarder is free from temperature down-regulation, in which the braking torque of the retarder is limited depending on the temperature of the working medium.

14. The drive train according to claim 11, characterized in that the retarder is free from temperature down-regulation, in which the braking torque of the retarder is limited depending on the temperature of the working medium.

15. The drive train according to claim 12, characterized in that the retarder is free from temperature down-regulation, in which the braking torque of the retarder is limited depending on the temperature of the working medium.

16. The drive train according to claim 10, characterized in that the retarder is positioned to be connected with the power take-off shaft on the side of the main output shaft of the drive engine, which power take-off shaft is determined for the connection of a transmission which is connected in series with the drive engine in the drive power flow and via which the drive wheels or the other unit are driven.

17. The drive train according to claim 11, characterized in that the retarder is positioned to be connected with the power take-off shaft on the side of the main output shaft of the drive engine, which power take-off shaft is determined for the connection of a transmission which is connected in series with the drive engine in the drive power flow and via which the drive wheels or the other unit are driven.

18. The drive train according to claim 12, characterized in that the retarder is positioned to be connected with the power take-off shaft on the side of the main output shaft of the drive engine, which power take-off shaft is determined for the connection of a transmission which is connected in series with the drive engine in the drive power flow and via which the drive wheels or the other unit are driven.

19. The drive train according to claim 13, characterized in that the retarder is positioned to be connected with the power take-off shaft on the side of the main output shaft of the drive engine, which power take-off shaft is determined for the connection of a transmission which is connected in series with the drive engine in the drive power flow and via which the drive wheels or the other unit are driven.

20. The drive train according to claim 14, characterized in that the retarder is positioned to be connected with the power take-off shaft on the side of the main output shaft of the drive engine, which power take-off shaft is determined for the connection of a transmission which is connected in series with the drive engine in the drive power flow and via which the drive wheels or the other unit are driven.

21. The drive train according to claim 15, characterized in that the retarder is positioned to be connected with the power take-off shaft on the side of the main output shaft of the drive engine, which power take-off shaft is determined for the connection of a transmission which is connected in series with the drive engine in the drive power flow and via which the drive wheels or the other unit are driven.

22. The drive train according to claim 10, characterized in that the working chamber of the retarder is always filled with working medium, especially the same quantity of working medium, and the retarder can be activated and deactivated in such a way that the drive of the primary wheel can be interrupted, especially by means of a synchronizing clutch, and/or the drive of the secondary wheel can be interrupted in the case of a secondary wheel which is driven in opposite direction to the primary wheel, especially by means of a synchronizing clutch, and/or a torsion-proof support of the secondary wheel can be selectively interrupted in the case of a stationary secondary wheel, especially by means of a synchronizing clutch.

23. The drive train according to claim 11, characterized in that the working chamber of the retarder is always filled with working medium, especially the same quantity of working medium, and the retarder can be activated and deactivated in such a way that the drive of the primary wheel can be interrupted, especially by means of a synchronizing clutch, and/or the drive of the secondary wheel can be interrupted in the case of a secondary wheel which is driven in opposite direction to the primary wheel, especially by means of a synchronizing clutch, and/or a torsion-proof support of the secondary wheel can be selectively interrupted in the case of a stationary secondary wheel, especially by means of a synchronizing clutch.

24. The drive train according to claim 12, characterized in that the working chamber of the retarder is always filled with working medium, especially the same quantity of working medium, and the retarder can be activated and deactivated in such a way that the drive of the primary wheel can be interrupted, especially by means of a synchronizing clutch, and/or the drive of the secondary wheel can be interrupted in the case of a secondary wheel which is driven in opposite direction to the primary wheel, especially by means of a synchronizing clutch, and/or a torsion-proof support of the secondary wheel can be selectively interrupted in the case of a stationary secondary wheel, especially by means of a synchronizing clutch.

25. The drive train according to claim 10, characterized in that the retarder is associated with a filling device for selective filling of the working chamber with working medium, and the filling device releases a feed line for the working medium into the working chamber or displaces a predetermined working medium storage volume into the working chamber, and for the purpose of deactivating the retarder blocks the feed line and/or opens a discharge of the working chamber or withdraws the working medium from the working chamber.

26. The drive train according to claim 11, characterized in that the retarder is associated with a filling device for selective filling of the working chamber with working medium, and the filling device releases a feed line for the working medium into the working chamber or displaces a predetermined working medium storage volume into the working chamber, and for the purpose of deactivating the retarder blocks the feed line and/or opens a discharge of the working chamber or withdraws the working medium from the working chamber.

27. The drive train according to claim 12, characterized in that the retarder is associated with a filling device for selective filling of the working chamber with working medium, and the filling device releases a feed line for the working medium into the working chamber or displaces a predetermined working medium storage volume into the working chamber, and for the purpose of deactivating the retarder blocks the feed line and/or opens a discharge of the working chamber or withdraws the working medium from the working chamber.

28. A method for setting the braking torque of a hydrodynamic retarder in a drive train according to claim 10, characterized in that the braking torque is varied in two steps exclusively between a deactivated state of the retarder in which no braking torque is generated and an activated state in which braking torque is generated in one single switching step.

29. The method according to claim 28, characterized in that in the activated state of the retarder the braking torque is set independent of the temperature of the working medium.
